(19) United States
(12) Patent Application Publication
(10) Pub. No.: US 2025/0138527 A1
(43) Pub. Date: May 1, 2025

(54) INTERFACE FOR EXTERNAL VEHICLE CONTROL

(71) Applicant: Ford Global Technologies, LLC, Dearborn, MI (US)

(72) Inventors: Pietro Buttolo, Dearborn Heights, MI (US); Joseph Dorigo, Plymouth, MI (US); John Eric Rollinger, Troy, MI (US); Matthew Ryan Preston, Whitmore Lake, MI (US); Scott Steadmon Thompson, Belleville, MI (US); David Hancock, South Rockwood, MI (US)

(73) Assignee: Ford Global Technologies, LLC, Dearborn, MI (US)

(21) Appl. No.: 18/500,007

(22) Filed: Nov. 1, 2023

(51) Int. Cl. G05D 1/00; G06F 3/041; G06F 3/044

(52) U.S. Cl. CPC G05D 1/0016; G06F 3/0414; G06F 3/044; G06F 2203/04105

(57) ABSTRACT

An interface configured to be removably attached to a vehicle exterior surface is disclosed. The interface may include a sensor unit configured to receive user inputs associated with at least one of a vehicle longitudinal movement and a vehicle steering wheel rotation. The interface may further include an interface communication module communicatively coupled with the sensor unit. The interface communication module may be configured to communicatively couple with a vehicle communication module when the interface may be attached to the vehicle exterior surface. The interface communication module may further obtain the user inputs from the sensor unit when the interface communication module may be coupled with the vehicle communication module, and transmit the user inputs to the vehicle communication module to cause a vehicle movement based on the user inputs.

### FIELD

The present disclosure relates to an interface for external vehicle control and more particularly to an interface configured to enable vehicle movement from outside a vehicle.

### BACKGROUND

Users may move their vehicles over relatively short distances frequently when the users may be performing outdoor activities or tasks. For example, a user may frequently move the user's vehicle over short distances (e.g., 5-10 meters) as the user performs the activity.

It may be inconvenient for the user to frequently enter and move the vehicle and then exit the vehicle multiple times to perform the activity, and hence the user may not prefer to enter the vehicle frequently when the user may be performing such activities. Therefore, it may be desirable to have a system that may enable the user to conveniently move the vehicle over relatively short distances without repeatedly entering and exiting the vehicle.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an environment in which techniques and structures for providing the systems and methods disclosed herein may be implemented.

FIG. 2 depicts a pressure sensor associated with an external interface in accordance with the present disclosure.

FIG. 3 depicts a first enclosing member associated with an external interface in accordance with the present disclosure.

FIG. 4 depicts a second enclosing member associated with an external interface in accordance with the present disclosure.

FIG. 5 depicts a rotary position sensing element associated with an external interface in accordance with the present disclosure.

FIG. 6 depicts a top view of an external interface in accordance with the present disclosure.

FIG. 7 depicts different orientations of an external interface associated with different vehicle movements in accordance with the present disclosure.

FIG. 8 depicts an elongated connector configured to connect an external interface with a vehicle exterior surface in accordance with the present disclosure.

FIG. 9 depicts a block diagram of a system to cause and control vehicle movement in accordance with the present disclosure.

FIG. 10 depicts a flow diagram of a method for causing and controlling vehicle movement in accordance with the present disclosure.

### DETAILED DESCRIPTION

### Overview

The present disclosure describes an interface that may be removably attached to a vehicle exterior surface and may be used by a user to cause and control a vehicle movement. For example, the interface may be removably attached to a top surface of a vehicle exterior sidewall, a vehicle cargo bed, and/or the like. The interface may include a sensor unit that may be configured to receive user inputs associated with a vehicle longitudinal movement or a vehicle steering wheel rotation and transmit the user inputs to a vehicle. The vehicle may receive the user inputs and may cause the vehicle movement based on the user inputs. For example, the vehicle may move forward or backwards and/or cause the vehicle steering wheel to rotate left or right based on the user inputs. In this manner, the user may cause and control the vehicle movement from outside the vehicle by using the interface and may not enter a vehicle interior portion to move the vehicle.

In some aspects, the sensor unit may include one or more pressure sensors that may receive the user inputs associated with the vehicle longitudinal movement and may cause the vehicle movement based on the pressure applied by the user on the pressure sensors. In an exemplary aspect, the pressure sensors may generate an electric current or a command signal based on the pressure applied by the user on the pressure sensors, when the user applies a push or pull pressure on the pressure sensors. The pressure sensors may transmit the generated electric current or command signal to the vehicle, which may cause the vehicle longitudinal movement and control vehicle speed based on the generated electric current or command signal.

In additional aspects, the sensor unit may include a rotary position sensing element that may be configured to receive the user inputs associated with the vehicle steering wheel rotation. The sensor unit may additionally or alternatively receive the user inputs associated with the vehicle steering wheel rotation based on the pressure sensors described above. Responsive to receiving the user inputs associated with the vehicle steering wheel rotation, the sensor unit may transmit the user inputs to the vehicle to cause the vehicle steering wheel rotation based on the user inputs.

The interface may be of any shape that may facilitate the user to conveniently provide inputs to the vehicle to cause and control vehicle movement. In an exemplary aspect, the interface may be dome-shaped. In another exemplary aspect, the interface may be shaped as a cuboid with flat walls. In yet another exemplary aspect, the interface may be shaped as an elongated rod (e.g., like a joystick). In some aspects, the interface may be a high impedance joystick that may include a stiff compliant mechanism to enable vehicle longitudinal movement or vehicle steering wheel rotation.

The present disclosure discloses an interface that may be removably attached to a vehicle exterior surface and may enable the user to cause and control the vehicle movement without having to enter the vehicle interior portion. Since the user is not required to enter the vehicle to cause the vehicle movement, the interface may facilitate the user in performing outdoor activities such as farming, laying fences, etc., which may require frequent vehicle movement over short distances. Further, the interface is easy to attach to the vehicle exterior surface, thus enhancing ease of use for the user.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

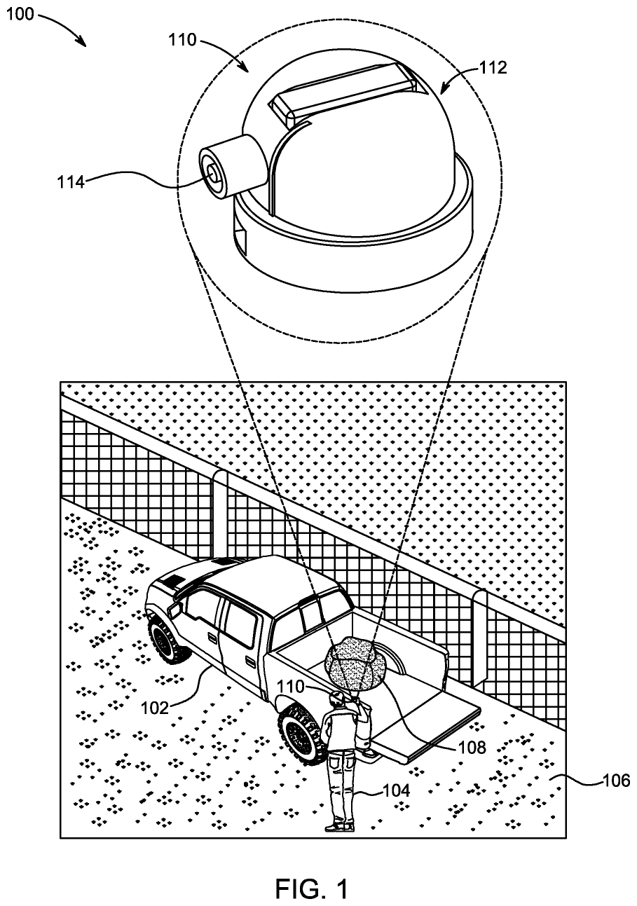

FIG. 1 depicts an example environment 100 in which techniques and structures for providing the systems and methods disclosed herein may be implemented. The environment 100 may include a vehicle 102 and a user 104. The user 104 may be performing an outdoor activity in a farm 106 where the vehicle 102 may be located. For example, the user 104 may be sowing plants on a farm periphery or may be laying fences. The user 104 may be using vehicle cargo bed to store material 108 that may be required to perform the outdoor activity, e.g., sand, plants, equipment/tools, manure, and/or the like. In some aspects, the user 104 may be required to move the vehicle 102 frequently over short distances (e.g., 5-10 meters) as the user 104 performs the outdoor activity around the farm periphery.

The vehicle 102 may take the form of any passenger or commercial vehicle such as, for example, a car, a work vehicle, a crossover vehicle, a van, a minivan, etc. Further, the vehicle 102 may be a manually driven vehicle and/or may be configured to operate in a fully autonomous (e.g., driverless) mode or a partially autonomous mode and may include any powertrain such as, for example, a gasoline engine, one or more electrically-actuated motor(s), a hybrid system, etc.

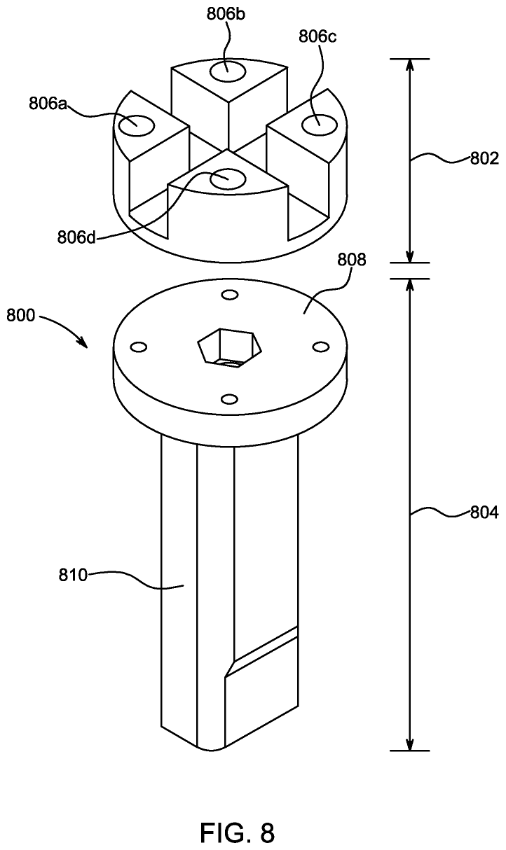

The environment 100 may further include an external interface 110 (or interface 110) that may be configured to be removably attached to a vehicle exterior surface (or a vehicle interior surface). In some aspects, the vehicle exterior surface may include one or more cavities or slots into which the user 104 may attach or “plug-in” the interface 110. As an example, the cavities or slots may be disposed on a top surface of vehicle side walls, on right and left edges of a vehicle bumper, a vehicle cargo bed, and/or the like. The user 104 may removably attach the interface 110 to the cavities or slots via an elongated connector (shown as connector 800 in FIG. 8) that may be inserted into the cavities or slots. In the exemplary aspect depicted in FIG. 1, the interface 110 is attached to the top surface of a vehicle side wall, although the present disclosure is not limited to such an aspect.

The interface 110 may be configured to cause and/or control vehicle movement based on user inputs. In some aspects, the user 104 may not be required enter and exit the vehicle 102 multiple times to frequently move the vehicle 102 over the short distances around the farm periphery by using the interface 110. Since the interface 110 may be configured to be removably attached to the vehicle exterior surface, the user 104 may conveniently cause and control the vehicle movement from outside the vehicle 102 by using the interface 110.

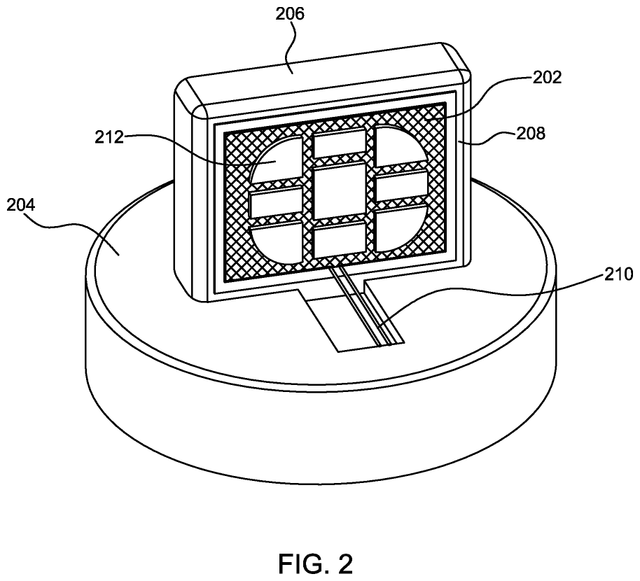

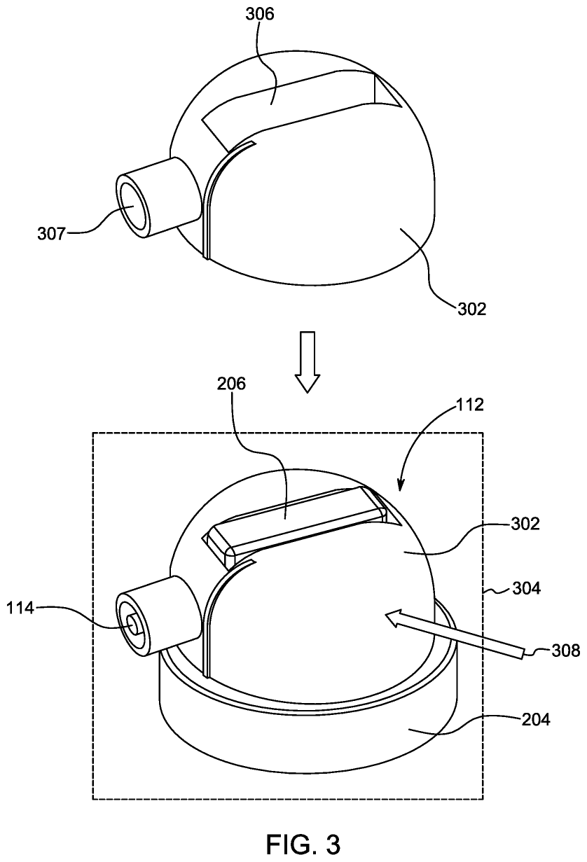

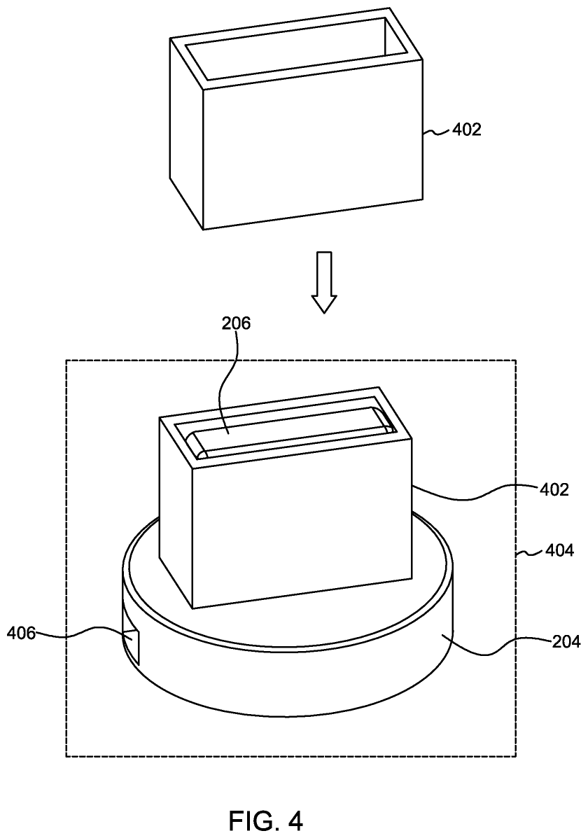

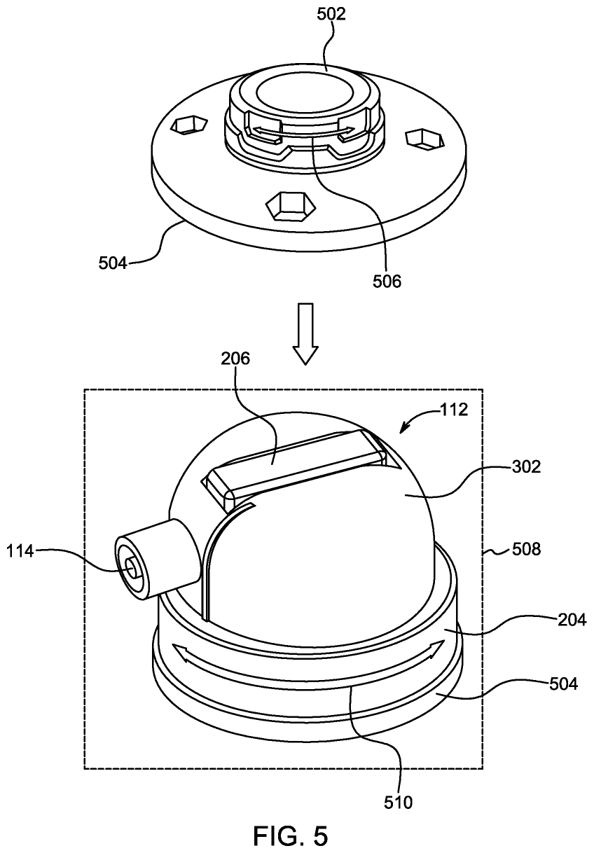

The interface 110 may include a sensor unit 112 that may be configured to receive user inputs associated with a vehicle longitudinal or linear movement (e.g., vehicle movement in forward or backward direction) and/or a vehicle steering wheel rotation angle or torque. The sensor unit 112 may include a plurality of units including, but not limited to, one or more pressure or force sensors (shown as pressure sensor 202 in FIG. 2), an enclosing member (shown as enclosing members 302, 402 in FIGS. 3 and 4) configured to enclose the pressure sensors, a rotary position sensing element (shown as rotary position sensing element 502 in FIG. 5), and/or the like. In an exemplary aspect, the user 104 may “push” or “pull” the interface 110/sensor unit 112 in the forward or backward direction relative to a vehicle longitudinal axis to provide the user inputs to the sensor unit 112 to move the vehicle 102 linearly forward or backward (i.e., to cause vehicle longitudinal movement). Further, the user 104 may rotate axially or tilt laterally left or right the interface 110/sensor unit 112 to provide the user inputs to the sensor unit 112 to cause vehicle steering wheel rotation. In this manner, the user 104 may cause and control the vehicle movement without having to enter the vehicle 102 (or a vehicle interior portion).

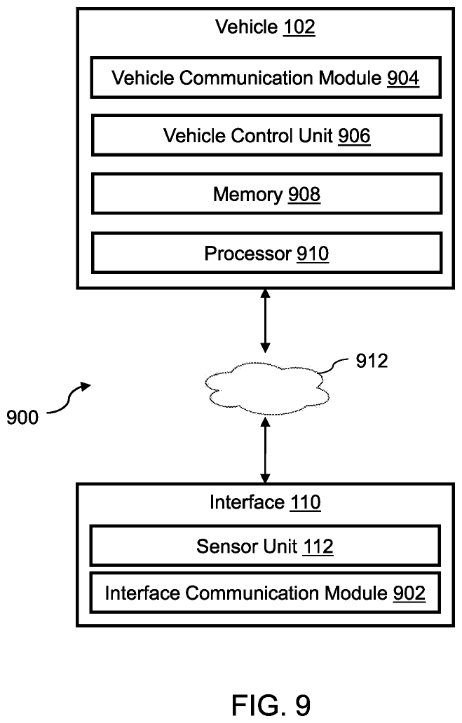

In some aspects, the interface 110 may further include an interface communication module (shown as interface communication module 902 in FIG. 9) that may be wirelessly or via a wired connection coupled with a vehicle communication module (shown as vehicle communication module 904 in FIG. 9) associated with the vehicle 102. Responsive to receiving the user inputs, the sensor unit 112 may transmit the user inputs (in the form of electric current, voltage change, command signals, and/or the like, generated by the sensor unit 112 based on the user inputs) to the interface communication module, which in turn may transmit the user inputs to the vehicle communication module. Responsive to obtaining the user inputs via the vehicle communication module, the vehicle 102 may cause the vehicle movement. For example, when the user 104 pushes the interface 110 in a forward direction relative to the vehicle longitudinal axis, the vehicle 102 may move forward. In some aspects, a vehicle speed in the forward direction may correspond to a pressure or a force with which the user 104 pushes the interface 110 forward. Similarly, when the user 104 rotates the interface 110 axially in a right direction, the vehicle steering wheel may also rotate in the same direction causing lateral vehicle movement.

In additional aspects, the interface 110 may include a dedicated actuator 114 (or a hard button) that may be disposed anywhere on a body associated with the interface 110. The actuator 114 may be configured to activate and enable the sensor unit 112 to receive the user inputs when the actuator 114 may be actuated. For example, to enable the sensor unit 112 to receive the user inputs, the user 104 may “press” the actuator 114. Responsive to the user 104 pressing/activating the actuator 114, the sensor unit 112 may receive the user inputs associated with the vehicle longitudinal movement and/or the vehicle steering wheel rotation. In some aspects, the actuator 114 may ensure that the sensor unit 112 does not inadvertently receive the user inputs when the user 104 does not intend the vehicle 102 to move, or treat push/pull/rotation action on the interface 110 caused by any other object (e.g., a tool, a broom, etc.) as the user inputs. The user 104 may activate the actuator 114 only when the user 104 intends the vehicle 102 to move, thereby reducing probability of false readings by the sensor unit 112.

Although the description above describes an aspect where the actuator 114 is a button disposed on the interface body, the present disclosure is not limited to such an aspect. In alternative aspects, the actuator 114 may be a proximity sensor, a capacitive sensor, and/or the like, which may be configured to determine a presence of a biological unit (e.g., a user hand/palm) on the interface body. Responsive to such determination, the actuator 114 may enable the sensor unit 112 to receive the user inputs.

Although FIG. 1 depicts the interface 110 as having a dome-shaped structure including pressure sensors, the present disclosure is not limited to such an interface structure. In other aspects (not shown), the interface 110 may be shaped as a rod, e.g., a joystick, which may be attached to the vehicle exterior surface. In an exemplary aspect, the joystick may be a high impedance joystick that may include stiff compliant mechanism. When the interface 110 is a high impedance joystick, the user 104 may apply a forward push or backward pull (with greater force than the force applied to the dome-shaped interface) to cause vehicle forward or backward movement. Further, the user 104 may tilt the joystick left or right to cause vehicle steering wheel rotation. Furthermore, in this case, one or more portions (e.g., a top portion) of the joystick may include capacitive sensors that may act as the actuator 114 described above. In addition, when the interface 110 is a high impedance joystick, higher force on the joystick may increase vehicle speed (and vice-versa). In an exemplary aspect, when the interface 110 is a high impedance joystick, the joystick may be attached anywhere on the vehicle cargo bed.

Further details associated with the interface 110 are described below in conjunction with the subsequent figures.

The vehicle 102 and the interface 110 implement and/or perform operations, as described here in the present disclosure, in accordance with the owner manual and safety guidelines. In addition, any action taken by the user 104 based on recommendations or notifications provided by the vehicle 102 should comply with all the rules specific to the location and operation of the vehicle 102 (e.g., Federal, state, country, city, etc.). The recommendation or notifications, as provided by the vehicle 102, should be treated as suggestions and only followed according to any rules specific to the location and operation of the vehicle 102.

FIG. 2 depicts a pressure sensor 202 associated with the interface 110 in accordance with the present disclosure. The pressure sensor 202 may be part of the sensor unit 112 described above. FIG. 2 specifically depicts an interior portion of the sensor unit 112, which may include, in addition to the pressure sensor 202, a support base 204 and a vertical pad 206 (or paddle) that may be disposed perpendicular to the support base 204. When the interface 110 may be disposed or attached on the vehicle exterior surface (e.g., on the vehicle side wall), the support base 204 may be disposed parallel to the surface of the vehicle side wall or the vehicle cargo bed, and the vertical pad 206 may be disposed perpendicular to the surface of the vehicle side wall or the vehicle cargo bed. The support base 204 and the vertical pad 206 may be of any shape. In the exemplary aspect depicted in FIG. 2, the support base 204 is shown to be circular and the vertical pad 206 is shown to be square/rectangular in shape, although the present disclosure is not limited to these shapes.

The pressure sensor 202 may be attached to a first surface 208 of the vertical pad 206. In some aspects, a second surface (not shown in FIG. 2) of the vertical pad 206 may include another pressure sensor (not shown) that may be similar to the pressure sensor 202. The second surface may be opposite to the first surface 208.

Examples of the pressure sensor 202 include, but are not limited to, a force sensitive resistor, a piezoelectric sensor, an inductive sensor, a capacitive sensor, and/or the like. In some aspects, the pressure sensor 202 may be configured to generate an electric signal/current when pressure may be applied by the user 104 on the pressure sensor 202. The amount of electric current may depend on the pressure applied by the user 104 on the pressure sensor 202. For example, the pressure sensor 202 may generate a greater amount of electric current when the user 104 applies a higher pressure on the pressure sensor 202, and vice-versa. In this manner, the generated electric current may be based on the user inputs provided by the user 104 on the pressure sensor 202 (or the pressure exerted by the user 104 on the pressure sensor 202). The pressure sensor 202 may transmit the generated electric current to the interface communication module via a wired connection 210. Responsive to receiving the generated electric current, the interface communication module may transmit command signals based on the electric current or the user inputs to the vehicle communication module, which may cause vehicle movement as described above in conjunction with FIG. 1.

In some aspects, the sensor unit 112 may further include one or more rubber or plastic membranes 212 that may be disposed over the pressure sensor 202, as shown in FIG. 2. Stated another way, the pressure sensor 202 may be disposed between the rubber or plastic membranes 212 and the first surface 208. The rubber or plastic membranes 212 may facilitate in enhancing response associated with the pressure sensor 202 and reducing false readings/errors in electric current generation. Specifically, the rubber or plastic membranes 212 may facilitate in focusing the user interaction (or user push) on the pressure sensor 202 and not on other areas surrounding the pressure sensor 202. Furthermore, using more than one rubber or plastic membrane (as shown in FIG. 2), as opposed to a single rubber or plastic membrane, reduces presence of any static stress that may result in false reading by the pressure sensor 202.

The sensor unit 112 may further include a plurality of additional units/components that may enhance sensor unit operation and reduce chances of false readings. Such additional units/components are described below.

FIG. 3 depicts an example first enclosing member 302 associated with the interface 110 in accordance with the present disclosure. The enclosing member 302 may be a part of the sensor unit 112 and may be configured to be placed over or attached to the support base 204. The enclosing member 302 may be made of flexible rubber or plastic. When the enclosing member 302 may be placed over the support base 204, the enclosing member 302 may cover or enclose the vertical pad 206 including the pressure sensor 202 and the rubber or plastic membranes 212, as shown in view 304 of FIG. 3.

In the exemplary aspect depicted in FIG. 3, the enclosing member 302 is dome-shaped, with a first opening 306 at an enclosing member top wall and a second opening 307 at an enclosing member side wall. In some aspects, the enclosing member 302 may be hollow. When the enclosing member 302 may be placed over the support base 204, a top part/portion of the vertical pad 206 may protrude from the first opening 306 and the actuator 114 may protrude from the second opening 307, as shown in the view 304. In some aspects, dimensions and shape of the first opening 306 may correspond to vehicle pad dimensions and shape.

During operation, the user 104 may place user's hand/palm over the enclosing member 302 and apply a forward push in a direction 308 to cause the vehicle 102 to move forward. Responsive to receiving the user's push in the direction 308, an inner wall of the first opening 306 may touch the rubber or plastic membranes 212, thereby transmitting the user's push to the rubber or plastic membranes 212. The rubber or plastic membranes 212 may in turn transmit the user's push to the pressure sensor 202, which generates the electric current based on the pressure applied by the user 104, as described above. In this manner, the user 104 may enable the pressure sensor 202 to generate the electric current (and hence cause a vehicle movement in the direction 308, i.e., a forward vehicle movement) by applying a push to the enclosing member 302. The user 104 may similarly pull the enclosing member 302 from a direction opposite to the direction 308 to cause a vehicle movement in the direction opposite to the direction 308 (i.e., a reverse vehicle movement). In this manner, the sensor unit 112 (or the pressure sensor 202) receives the user inputs associated with the vehicle longitudinal or linear movement (i.e., forward or backward vehicle movement) when the user 104 applies a push or pull pressure on the enclosing member 302.

In some aspects, the enclosing member 302 may ensure that the pressure sensor 202 is protected from any inadvertent pressure/force that may get applied on the pressure sensor 202 from any object, such as a broom, a tool, and/or the like, falling on the interface 110. Stated another way, the enclosing member 302 may ensure that the pressure sensor 202 is not engaged when the user 104 is not engaging/interacting with the interface 110 or the sensor unit 112. The function of the enclosing member 302 is to apply a consistent and repeated pressure on the pressure sensor 202, and only in a direction desired by the user 104, when the user 104 applies a pull/push pressure or force on the enclosing member 302.

Although FIG. 3 depicts a dome-shaped enclosing member 302, the present disclosure is not limited to such an enclosing member shape. The enclosing member 302 may be of any other shape, without departing from the present disclosure scope. An example of a different enclosing member shape is depicted in FIG. 4 and described below.

FIG. 4 depicts an example second enclosing member 402 associated with the interface 110 in accordance with the present disclosure. The enclosing member 402 may perform similar function as the enclosing member 302; however, the enclosing member 402 may be shaped as a hollow cuboid having flat/linear walls. The enclosing member 402 may be placed over the support base 204 and may enclose the vertical pad 206, as shown in view 404 of FIG. 4. In the exemplary aspect depicted in FIG. 4, the enclosing member 402 may not include an opening for the actuator 114. In this case, the support base 204 may include an opening 406 through which the actuator 114 may protrude. Dimensions and shape of the enclosing member 402 may correspond to the vehicle pad dimensions and shape.

Since the functions of the enclosing members 302 and 402 are similar to each other, the function of the enclosing member 402 is not described again here for the sake of simplicity and conciseness.

FIG. 5 depicts an example rotary position sensing element 502 associated with the interface 110 in accordance with the present disclosure. The rotary position sensing element 502 may be a part of the sensor unit 112. Stated another way, in addition to the pressure sensor 202, the support base 204 and the vertical pad 206, the sensor unit 112 may include the rotary position sensing element 502.

As described above, the pressure sensor 202 may be configured to receive the user inputs associated with the vehicle longitudinal or linear movement. While the pressure sensor 202 receives the user inputs associated with the vehicle longitudinal/linear movement, the sensor unit 112 may be configured to receive the user inputs associated with the vehicle steering wheel rotation/torque via the rotary position sensing element 502, as described below.

In some aspects, in addition to the units described above, the interface 110 may include a mounting base 504 that may be configured to be removably attached to the vehicle exterior surface via an elongated connector (shown as connector 800 in FIG. 8). The rotary position sensing element 502 may be disposed on the mounting base 504 such that the rotary position sensing element 502 may rotate relative to the mounting base 504 in clockwise or counterclockwise direction, as shown by a first bi-directional arrow 506. Further, the support base 204 and the vertical pad 206 including the pressure sensor 202 may be placed/disposed on the mounting base 504, such that the rotary position sensing element 502 may be disposed between the mounting base 504 and the vertical pad 206 including the pressure sensor 202 (and the support base 204).

In some aspects, in a fully assembled state of the interface 110 (shown in view 508 of FIG. 5), when the user 104 rotates the sensor unit 112 or the enclosing member 302 in a clockwise or counterclockwise direction (as shown by a second bi-directional arrow 510), the rotary position sensing element 502 may also rotate in the same direction. Rotation of the rotary position sensing element 502 may generate an electric signal that the sensor unit 112 may transmit to the interface communication module. The electric signal may be indicative of or correspond to the angle of rotation of the rotary position sensing element 502. The interface communication module may transmit the generated electric signal as a command signal to the vehicle communication module, which in turn may cause the vehicle steering wheel to rotate based on the received command signal. In this manner, the user 104 may cause the vehicle steering wheel rotation by rotating the sensor unit 112 or the enclosing member 302 in the clockwise or counterclockwise direction.

In some aspects, the rotary position sensing element 502 may be a spring-loaded rotary position sensing element. In other aspects, an arrangement alternative to the spring-loaded rotary position sensing element may be used to receive the user inputs associated with the vehicle steering wheel rotation. For example, in an exemplary aspect, one or more external springs (not shown) may be disposed between the mounting base 504 and the support base 204 or the vertical pad 206. In this case, the interface 110 may further include a rotary position sensor, e.g., a hall-effect sensor, an encoder, and a potentiometer to measure the support base/vertical pad rotation relative to the mounting base 504 (when the user 104 rotates the enclosing member 302) and generate the electric signal/command signal described above to cause the vehicle steering wheel rotation.

In further aspects, one or more elasto-switches may be disposed in proximity to bottom portions of the first surface 208 and the second surface (which may be opposite to the first surface 208) of the vertical pad 206. In this case, when the user 104 rotates the enclosing member 302, one or more enclosure member interior walls that form the first opening 306 may touch or push against the elasto-switch(s) disposed either on the first surface 208 or the second surface (depending on the angle of rotation of the enclosing member 302), thus triggering the elasto-switch(s). Triggering of the elasto-switch(s) may generate the electric signal/command signal described above that may cause the vehicle steering wheel rotation.

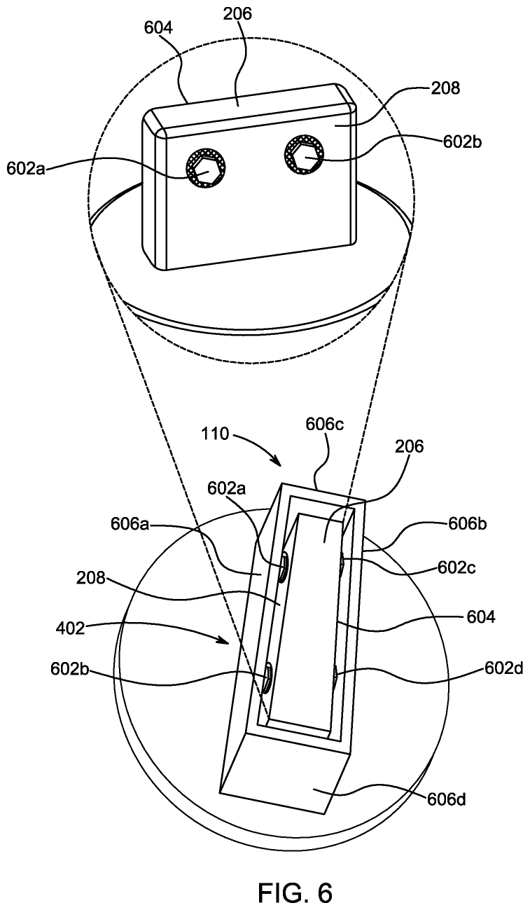

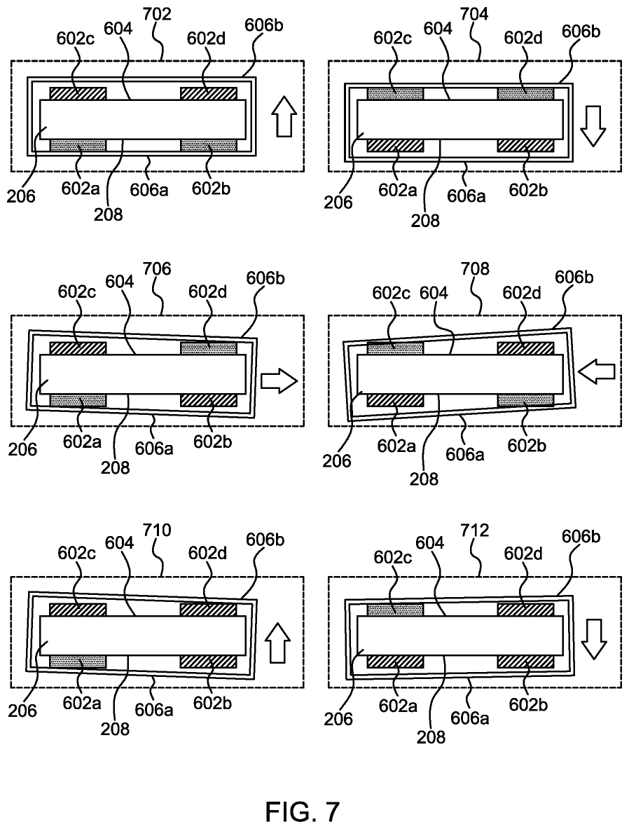

In alternative aspects, the sensor unit 112 may not include any spring-loaded rotary position sensing element, external springs and/or elasto-switches to measure the support base/vertical pad rotation. In this case, the sensor unit 112 may instead include more than one pressure/force sensors on each of the first surface 208 and the second surface of the vertical pad 206 that may facilitate in receiving/determining the user inputs associated with the vehicle steering wheel rotation, as described below in conjunction with FIGS. 6 and 7.

FIG. 6 depicts a top view of the interface 110 in accordance with the present disclosure. While describing FIG. 6, references will be made to FIG. 7. In the exemplary aspect depicted in FIGS. 6 and 7, instead of a single pressure sensor 202, the vertical pad 206 may include four pressure sensors 602a, 602b, 602c and 602d. The pressure sensors 602a, 602b may be disposed on the first surface 208, and the pressure sensors 602c, 602d may be disposed on a second surface 604 of the vertical pad 206. As shown in FIG. 6, the first surface 208 may be opposite to the second surface 604.

Further, as shown in FIG. 6, the vertical pad 206 may be enclosed by the enclosing member 402, which may include a first wall 606a, a second wall 606b and sidewalls 606c, 606d. The first wall 606a may be parallel to the second wall 606b and perpendicular to the sidewalls 606c, 606d. In some aspects, a predefined small distance or gap may exist between the pressure sensors 602a-602d and respective first and second walls 606a, 606b.

During operation, when the user 104 desires to cause the vehicle 102 to move forward along the vehicle longitudinal axis, the user 104 may provide a forward push to the first wall 606a so that the first wall 606a may touch and press the pressure sensors 602a, 602b simultaneously, as shown in view 702 of FIG. 7. Responsive to the first wall 606a touching the pressure sensors 602a, 602b simultaneously, the sensor unit 112 may generate a first electric current/command signal and transmit the generated first electric current/command signal to the vehicle communication module (via the interface communication module) to cause a vehicle forward movement.

Similarly, when the user 104 desires to cause the vehicle 102 to move backwards in a reverse direction along the vehicle longitudinal axis, the user 104 may provide a push to the second wall 606b so that the second wall 606b may touch and press the pressure sensors 602c, 602d simultaneously, as shown in view 704 of FIG. 7. Responsive to the second wall 606b touching the pressure sensors 602c, 602d simultaneously, the sensor unit 112 may generate a second electric current/command signal and transmit the generated second electric current/command signal to the vehicle communication module (via the interface communication module) to cause a vehicle reverse movement.

When the user 104 desires to rotate the vehicle steering wheel in a right direction, the user 104 may provide a push to a left side portion of the first wall 606a, thereby causing the first wall 606a to touch the pressure sensor 602a and the second wall 606b to touch the pressure sensor 602d, as shown in view 706 of FIG. 7. Responsive to such user action, the sensor unit 112 may generate a third electric current/command signal to cause the vehicle steering wheel to move in the right direction.

Similarly, when the user 104 desires to rotate the vehicle steering wheel in a left direction, the user 104 may provide a push to a right side portion of the first wall 606a, thereby causing the first wall 606a to touch the pressure sensor 602b and the second wall 606b to touch the pressure sensor 602c, as shown in view 708 of FIG. 7. Responsive to such user action, the sensor unit 112 may generate a fourth electric current/command signal to cause the vehicle steering wheel to move in the left direction.

When the user 104 desires to cause the vehicle 102 to move forward and the vehicle steering wheel to rotate in the right direction, the user 104 may provide a slight push to the left side portion of the first wall 606a, thereby causing the first wall 606a to touch the pressure sensor 602a, as shown in view 710 of FIG. 7. Responsive to such user action, the sensor unit 112 may generate a fifth electric current/command signal to cause the vehicle 102 to move forward and the vehicle steering wheel to rotate in the right direction.

Similarly, when the user 104 desires to cause the vehicle 102 to move backwards in the reverse direction and the vehicle steering wheel to rotate in the left direction, the user 104 may provide a slight push to the right side portion of the second wall 606b, thereby causing the second wall 606b to touch the pressure sensor 602c, as shown in view 712 of FIG. 7. Responsive to such user action, the sensor unit 112 may generate a sixth electric current/command signal to cause the vehicle 102 to move backwards and the vehicle steering wheel to rotate in the left direction.

Although FIG. 6 depicts the interface 110/sensor unit 112 to include the enclosing member 402, the same arrangement of the pressure sensors 602a-d and the walls 606a-d may operate equally efficiently when the enclosing member 402 is replaced with the enclosing member 302.

In further aspects, the vehicle 102 may implement a plurality of different processes to cause and control vehicle steering wheel movement based on inputs/signals obtained from the sensor unit 112. For example, the vehicle 102 may map the continuous rotational analog input of the interface 110/sensor unit 112, scaled by an appropriate factor. Further, when the user 104 centers the interface 110/sensor unit 112, the vehicle 102 may cause the vehicle steering wheel to center as well. In additional aspects, the vehicle steering wheel may turn in the direction indicated by the interface 110/sensor unit 112, with turning speed proportional to the interface/sensor unit angle. In this case, vehicle steering wheel centering may not be provided/implemented by the vehicle 102. In other aspects, the vehicle steering wheel may turn in the direction indicated by the interface 110/sensor unit at a constant turning speed based on the signals provided by the sensor unit 112. In this case, the vehicle steering wheel may self-center at a rate proportional to the forward/reverse vehicle speed. Stated another way, there may be no self-centering of vehicle steering wheel when the vehicle 102 may be stationary, and the self-centering may be more aggressive/pronounced the faster the vehicle 102 moves.

FIG. 8 depicts an example elongated connector 800 (or connector 800) configured to connect the interface 110 with a vehicle exterior surface in accordance with the present disclosure. The connector 800 may include a first portion 802 and a second portion 804.

In an exemplary aspect, the first portion 802 may be circular in shape and may include one or more connection structures 806a-d disposed on a first portion top surface. In some aspects, the connection structures 806a-d may be configured to couple with or removably attach with a bottom surface of the mounting base 504 of the interface 110, thereby enabling the interface 110 to removably attach with the first portion 802.

A first portion bottom surface may be configured to attach with a top surface 808 of the second portion 804. Further, a bottom part 810 of the second portion 804 may be configured to be inserted into the cavities or slots present on the vehicle exterior surface, thereby enabling the interface 110 to be placed or removably attached with the vehicle exterior surface. Specifically, the user 104 may attach the interface 110 to the first portion top surface and then attach the first portion 802 to the second portion 804 (or the first and second portions 802, 804 may be pre-attached with each other). Thereafter, the user 104 may insert the bottom part 810 into the cavities or slots present on the vehicle exterior surface, to secure the interface 110 on the vehicle exterior surface.

Connector shape depicted in FIG. 8 is for illustrative purpose only and should not be construed as limiting. The connector 800 may have any other shape, without departing from the present disclosure scope. Further, in some aspects, the connector 800 may be replaced by or may additionally include one or more of clamps, suction cups, magnets, mounting panels, and/or the like.

Although the description above describes an aspect where the interface 110 includes the pressure sensor 202 disposed on the vertical pad 206, the present disclosure is not limited to such an aspect. In alternative aspects, the interface 110 may be an elongated structure or a rod that may be inserted into the cavities or slots in the vehicle exterior surface, without departing from the present disclosure scope. In this case, the interface 110 may act like a joystick (e.g., a high impedance joystick with stiff compliant mechanism, as described above in conjunction with FIG. 1) that may be communicatively coupled with the vehicle 102. The user 104 may cause and control vehicle movement based on forward, backward, and/or sideways movement of the interface 110 (like a joystick movement). Furthermore, in this case, the position of the interface 110/joystick relative to its default position may enable the vehicle 102 to move fast or slow. For example, if the user 104 pushes the interface 110 forward such that the interface 110 gets displaced from its default position by 30 degrees, the vehicle 102 may move fast, as compared to a position when the interface 110 may be displaced by only 5 or 10 degrees.

FIG. 9 depicts a block diagram of a system 900 to cause and control vehicle movement in accordance with the present disclosure. The system 900 may include the vehicle 102 and the interface 110. The interface 110 may include the sensor unit 112 and an interface communication module 902 that may be communicatively coupled with the sensor unit 112 via the wired connection 210 (or wirelessly).

The vehicle 102 may include a vehicle communication module 904, a vehicle control unit (VCU) 906, a memory 908 and a processor 910. The vehicle communication module 904 may be configured to communicatively couple with external systems or devices wirelessly or via a wired connection. For example, the vehicle communication module 904 may be configured to communicatively couple with the interface communication module 902 via a wired connection or a wireless network 912.

In some aspects, the interface communication module 902 may communicatively couple with the vehicle communication module 904 via a wired connection when the interface 110 may be attached to the vehicle exterior surface (e.g., via the connector 800). On the other hand, when the interface communication module 902 may be configured to wirelessly connect with the vehicle communication module 904, the interface communication module 902 may communicatively couple with the vehicle communication module 904 via the wireless network 912 when the interface 110 may be disposed within a predefined distance of the vehicle exterior surface.

The wireless network 912 illustrates an example communication infrastructure in which the connected devices discussed in various embodiments of this disclosure may communicate. The wireless network 912 may be and/or include the Internet, a private network, public network or other configuration that operates using any one or more known communication protocols such as, for example, transmission control protocol/Internet protocol (TCP/IP), Bluetooth®, BLE, Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The VCU 906 may control vehicle operational aspects based on instructions or command signals received from the processor 910. For example, the VCU 906 may cause vehicle forward or backward/reverse movement, vehicle steering wheel rotation, stop vehicle movement, and/or the like, based on the instructions or command signals received from the processor 910.

The processor 910 may be disposed in communication with one or more memory devices disposed in communication with the respective computing systems (e.g., the memory 908 and/or one or more external databases not shown in FIG. 9). The processor 910 may utilize the memory 908 to store programs in code and/or to store data for performing operations in accordance with the disclosure. The memory 908 may be a non-transitory computer-readable storage medium or memory storing a program code that may enable the processor 910 to perform operations in accordance with the present disclosure. The memory 908 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In operation, the interface communication module 902 may communicatively couple with the vehicle communication module 904 when the interface 110 may be attached to the vehicle exterior surface or when the interface 110 may be disposed within a predefined distance of the vehicle exterior surface. Responsive to communicatively coupling with the vehicle communication module 904, the interface communication module 902 may obtain the user inputs associated with the vehicle longitudinal movement or the vehicle steering wheel rotation from the sensor unit 112. The interface communication module 902 may then transmit the user inputs (specifically electric current/command signals associated with the user inputs generated by the sensor unit 112) to the vehicle communication module 904 to cause a vehicle movement based on the user inputs.

The vehicle communication module 904 may receive the user inputs from the interface communication module 902. In addition, the processor 910 may determine whether the vehicle communication module 904 may be communicatively coupled with the interface communication module 902. Responsive to a determination that the vehicle communication module 904 may be communicatively coupled with the interface communication module 902, the processor 910 may obtain the user inputs from the vehicle communication module 904. The processor 910 may further cause, via the VCU 906, the vehicle movement based on the user inputs. For example, the processor 910 may cause the vehicle 102 to move forward or backwards and/or the vehicle steering wheel to rotate left or right based on the user inputs.

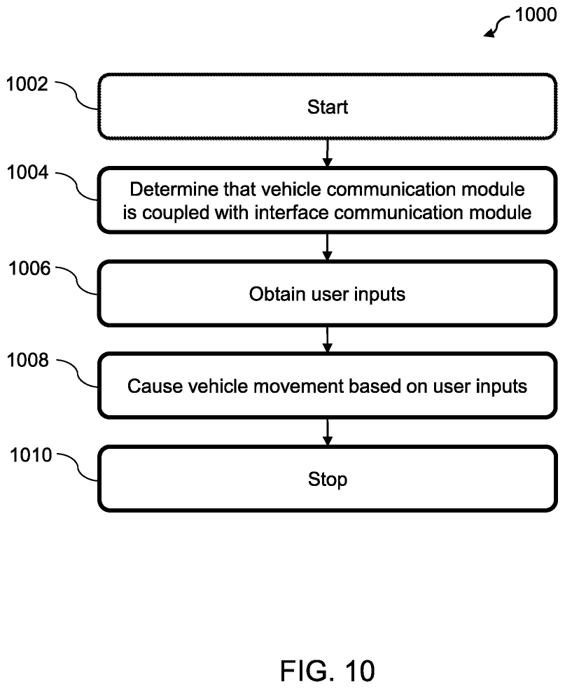

FIG. 10 depicts a flow diagram of an example method 1000 for causing and controlling vehicle movement in accordance with the present disclosure. FIG. 10 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 1000 starts at step 1002. At step 1004, the method 1000 may include determining, by the processor 910, that the vehicle communication module 904 may be communicatively coupled with the interface communication module 902. At step 1006, the method 1000 may include obtaining, by the processor 910, the user inputs from the vehicle communication module 904 responsive to determining that the vehicle communication module 904 may be communicatively coupled with the interface communication module 902. At step 1008, the method 1000 may include causing, by the processor 910, the vehicle movement based on the user inputs. The method 1000 may end at step 1010.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. An interface comprising:
a sensor unit configured to receive user inputs associated with at least one of a vehicle longitudinal movement and a vehicle steering wheel rotation; and
an interface communication module communicatively coupled with the sensor unit, wherein the interface communication module is configured to:
communicatively couple with a vehicle communication module when the interface is attached to a vehicle exterior surface;
obtain the user inputs from the sensor unit when the interface communication module is coupled with the vehicle communication module; and
transmit the user inputs to the vehicle communication module to cause a vehicle movement based on the user inputs.

2. The interface of claim 1, wherein the sensor unit comprises one or more pressure sensors.

3. The interface of claim 2 further comprising a mounting base, wherein the one or more pressure sensors are disposed on the mounting base.

4. The interface of claim 3, wherein the sensor unit further comprises a rotary position sensing element disposed between the mounting base and the one or more pressure sensors, wherein the sensor unit receives the user inputs associated with the vehicle steering wheel rotation via the rotary position sensing element.

5. The interface of claim 4, wherein the rotary position sensing element is a spring-loaded rotary position sensing element.

6. The interface of claim 2, wherein the one or more pressure sensors comprise at least one of a force sensitive resistor, a piezoelectric sensor, an inductive sensor and a capacitive sensor.

7. The interface of claim 2, wherein the sensor unit further comprises a plurality of rubber or plastic membranes disposed on the one or more pressure sensors.

8. The interface of claim 7, wherein the sensor unit further comprises an enclosing member configured to enclose the one or more pressure sensors and the plurality of rubber or plastic membranes, wherein the sensor unit receives the user inputs associated with the vehicle longitudinal movement when a user applies a push or pull pressure on the enclosing member.

9. The interface of claim 1, wherein the interface is removably attached to the vehicle exterior surface via an elongated connector that is configured to be inserted into a cavity disposed on the vehicle exterior surface.

10. The interface of claim 1 further comprising an actuator, wherein the sensor unit receives the user inputs when the actuator is activated by a user.

11. The interface of claim 10, wherein the actuator is a capacitive sensor.

12. A vehicle comprising:
a vehicle communication module configured to couple with an interface communication module associated with an external interface, wherein:
the external interface is configured to be removably attached to a vehicle exterior surface,
the vehicle communication module is configured to receive user inputs from the interface communication module when the vehicle communication module is coupled with the interface communication module,
the user inputs are associated with at least one of a vehicle longitudinal movement and a vehicle steering wheel rotation; and
a processor communicatively coupled with the vehicle communication module, wherein the processor is configured to:
determine that the vehicle communication module is coupled with the interface communication module;
obtain the user inputs from the vehicle communication module responsive to determining that the vehicle communication module is coupled with the interface communication module; and
cause a vehicle movement based on the user inputs.

13. The vehicle of claim 12, wherein the external interface is removably attached to the vehicle exterior surface via an elongated connector that is configured to be inserted into a cavity disposed on the vehicle exterior surface.

14. The vehicle of claim 12, wherein the external interface comprises a sensor unit configured to receive the user inputs.

15. The vehicle of claim 14, wherein the sensor unit comprises one or more pressure sensors.

16. The vehicle of claim 15, wherein the external interface further comprises a mounting base, and wherein the one or more pressure sensors are disposed on the mounting base.

17. The vehicle of claim 16, wherein the sensor unit further comprises a rotary position sensing element disposed between the mounting base and the one or more pressure sensors, and wherein the sensor unit receives the user inputs associated with the vehicle steering wheel rotation via the rotary position sensing element.

18. A method to cause a vehicle movement, the method comprising:
determining, by a processor, that a vehicle communication module is coupled with an interface communication module associated with an external interface, wherein:
the external interface is configured to be removably attached to a vehicle exterior surface,
the vehicle communication module is configured to receive user inputs from the interface communication module when the vehicle communication module is coupled with the interface communication module,
the user inputs are associated with at least one of a vehicle longitudinal movement and a vehicle steering wheel rotation;
obtaining, by the processor, the user inputs from the vehicle communication module responsive to determining that the vehicle communication module is coupled with the interface communication module; and
causing, by the processor, the vehicle movement based on the user inputs.

19. The method of claim 18, wherein the external interface comprises a sensor unit configured to receive the user inputs.

20. The method of claim 19, wherein the sensor unit comprises one or more pressure sensors.
